(19) United States
(12) Patent Application Publication
(10) Pub. No.: US 2025/0117946 A1
(43) Pub. Date: Apr. 10, 2025

(54) METHODS FOR DESIGNING A PRINTED IMAGE FOR A SECURITY FEATURE

(71) Applicant: Koenig & Bauer Banknote Solutions SA, Lausanne 22 (CH)

(72) Inventor: Robert Laird Stewart, Lausanne 22 (CH)

(73) Assignee: Koenig & Bauer Banknote Solutions SA, Lausanne 22 (CH)

(21) Appl. No.: 18/856,213

(22) PCT Filed: Apr. 12, 2023
(86) PCT No.: PCT/EP2023/059556

§ 371 Date: Oct. 11, 2024

(30) Foreign Application Priority Data
Apr. 12, 2022 (GB) 2205377.1

(51) Int. Cl. B42D 25/485; B42D 25/324; B42D 25/351

(52) U.S. Cl. CPC G06T 7/11; G06T 3/40; G06T 3/4023

(57) ABSTRACT

A method for designing a first layer of a printed image in a security feature is provided. The security feature comprising an array of optical elements overlaying the printed image, the method comprising: receiving an original image, the original image comprising rows of pixels extending in an x direction and columns of pixels extending in a y direction; selecting a first section of the original image; generating a first block by combining the pixels of the first section with pixels of the first section mirrored in both the x and y directions; and assigning to the first block a location within the first layer of the printed image, the location corresponding to the location of the first section within the original image. A method for producing a printed image, a printed image, a security feature, a security document, and non-transitory computer readable medium are also provided.

### FIELD

The present invention relates to methods for designing a printed image for a security feature. A section of an original image used to produce the printed image may be mirrored in multiple directions, thereby providing a more distinctive design.

### BACKGROUND

Many documents contain security features that assist with identifying counterfeit or forged documents. Many of these documents will contain security features that utilise micro-optics as such features are typically difficult to copy with the precision needed to produce a convincing forgery.

The micro-optics used in these documents often comprise an array of optical elements overlying a printed image made up of pixels. Viewing the printed image through the array of optical elements distorts the printed image and can lead to distinctive effects, particularly as the security feature is tilted to vary the angle between the viewer's eye and the plane of the security feature.

The more distinctive the effect produced by a security feature is, the more clearly it can be determined that the security feature (and its associated document) are genuine. Furthermore, the effects produced by security features are the product of complex interactions between the printed images and the array of optical elements. The arrangement of features in the printed image can lead to any number of effects, including magnification, implied depth, and animation. It can be difficult to ‘reverse engineer’ the interactions between printed images and arrays of optical elements which give rise to such effects, thereby making reproduction of the effects difficult to achieve. Nevertheless, especially with time and access to the security feature, forgery is possible.

The more effects that a printed image has, the more complex combinations of these effects can be. Combinations of animation and magnification, for example, may be more visually and mathematically complex than animation or magnification alone. In turn, it may be harder for a counterfeiter to recognise an effect or combination of effects and derive the arrangement of the printed image that gives rise to them. The more degrees of freedom that exist in the design of printed images, the broader the range of possible security features becomes. A broader range of possible security features leads to increased difficulty in ascertaining the underlying printed image, which is advantageous in deterring and defeating counterfeiting.

Therefore, there exists a need for improved printed image and security feature design, providing distinctive effects and underlying image/optical element interactions that are difficult to ascertain.

### SUMMARY

The invention is defined by the appended independent claims. Embodiments of the invention are defined by the dependent claims.

In a first aspect, there is provided a method for designing a first layer of a printed image in a security feature, the security feature comprising an array of optical elements overlaying the printed image, the method comprising: receiving an original image, the original image comprising rows of pixels extending in an x direction and columns of pixels extending in a y direction; selecting a first section of the original image; generating a first block by combining the pixels of the first section with pixels of the first section mirrored in both the x and y directions; and assigning to the first block a location within the first layer of the printed image, the location corresponding to the location of the first section within the original image.

In this way, the method provides a printed image with a unique arrangement, which can lead to distinctive effects when incorporated into a security feature. In particular, the mirroring of sections of the original image in both the x and the y direction ‘corrects’ for a phenomenon known as ‘frame skip’. Frame skip will be discussed in greater detail in due course. Briefly, frame skip occurs when a security feature is tilted by a viewer beyond a threshold angle, for example beyond 30° relative to the normal. Beyond this threshold angle, there is a mismatch between the printed image and the array of micro-optical elements overlaying it. This mismatch can be significant enough that each lens is focusing on a portion of the printed image not directly beneath the relevant lens, rather each is focusing on its neighbour's portion of the printed image. This leads to a particular visual characteristic in the security image.

By correcting ‘frame skip’, a smoother animation is achieved as the user rotates the security feature. This is not only distinctive and thus eases fast recognition of genuine security features, but also provides one further link in the chain between printed image and security feature appearance; the chain a counterfeiter must break in order to forge the security feature.

Generating a first block of the printed image may comprise: i) mirroring the pixels of the first section in the x direction, about the right edge of the first section; ii) mirroring the pixels of the result of step i in the y direction, about the lower edge of the result of step i; or i) mirroring the pixels of the first section in the y direction, about the lower edge of the first section; ii) mirroring the pixels of the result of step i in the x direction, about the right edge of the result of step i. It will be appreciated that mirroring might equivalently be performed about the left and upper edges, rather than the right and lower edges, respectively.

The method may further comprise: sizing the first block such that the size of the first block relative to the printed image is equal to the size of the first section relative to the original image.

In this way, certain patterns found in the original image can be replicated, albeit with appearance characteristics added, and appear at the same scale in the printed image. Maintaining the scale of recognisable objects in the original image can aid a viewer in determining the content of the printed image, thereby easing identification of genuine security features.

The first block may be sized to be overlaid by exactly one optical element of the array of optical elements.

The array of optical elements may comprise rows of optical elements extending in the x direction and columns of optical elements extending in the y direction, further comprising: rotating, by a rotation angle, the first layer of the printed image relative to the array of optical elements, such that respective rows and columns of blocks in the first layer and the rows and columns of the optical elements are offset by the rotation angle.

In this way, the method provides yet more distinctive characteristic to the printed image. By introducing a tilt to the printed image relative to the array of optical elements, a cyclical effect is generated for the security feature. Recognisable objects or patterns in the printed image no longer have vertical or horizontal alignment with the array of optical elements. Therefore, as the security feature is tilted, the viewer is presented with horizontally and vertically shifting elements of the printed image, which also cycle. The effect is demonstrated in the figures, with accompanying description to follow.

As with the correction for ‘frame skip’, this additional effect aids the distinctive character of the security feature, which is advantageous for fraud prevention and recognition of genuine security features.

The rotation angle may be between 0.1° and 5°, for example, between 0.1° and 2°, between 0.1° and 1°, or, preferably, between 0.1° and 0.6°. These angles have been found to be particularly effective at generating distinctive printed images, and thus distinctive security features.

In particular, these ranges are most effective for generating an oscillating effect in the security feature, somewhat visually akin to the movement of an object underwater. This underwater effect is especially recognisable for many, and provides a new category of distinctive character to compliment those such as magnification and animation.

The method may further comprise: selecting further sections of the original image; and, for each further section: generating a block, and assigning to the block a location within the printed image, the location corresponding to the respective location of the section in the original image, using the same generating and assigning steps applied to the first section and first block. Each block may correspond to one optical element in the array.

In this way, the entire original image can be transferred into a printed image, thereby retaining the content of the original image, such as any objects or patterns.

The method may further comprise: receiving a further original image; and designing a second layer of the printed image from the further original image, using the steps applied to the original image to design the first layer of the printed image, wherein the rotation angle applied to the first layer of the printed image is different to the rotation angle applied to the second layer of the printed image. The method may further comprise compositing the rotated first and second layers to form the printed image.

In this way, yet further distinctive character can be applied to the security feature, by varying the level of oscillation performed in different areas of the printed image. A background object of the printed image may, for example, be designed to oscillate more than a foreground object, thereby implying depth in the image. This is exemplary only, and any differing rotations applied to layers of the printed image will produce a more distinctive security feature, aiding recognition of genuine features and hindering counterfeiting. Indeed, a rotation angle of 0° may be applied to one layer and a non-zero rotation angle to another, thereby boosting the effect of the oscillations for objects in the rotated layer.

As used herein, compositing layers to form a printed image includes any physical or computational process by which the content of the layers are laid over one another and/or combined into a single printed image. For example, a physical process of compositing two layers is simply to print one on top of the other. Depending on the opacity of the inks used and other printing parameters selected by the designer, some or all of one layer may dominate or the colour values of the layers may combine. A computational compositing process may be performed, for example, using image processing software, such that a single printing process can be used to print the composite image. Any process by which visual elements from more than one layer are combined to produce a printed image is considered to be compositing those layers.

The original image may be an interlaced image. An interlaced image may be generated by interlacing an input image, and wherein interlacing an input image comprises: generating a plurality of frames of a multi-frame image, each frame comprising the input image at a different location within the frame; defining an arrangement of the plurality of frames, the arrangement comprising a grid; and interlacing the frames with one another according to the positions of the frames in the grid.

The first section may be selected to include only one portion of each interlaced frame.

The original image may be a multi-frame image comprising a plurality of frames and the first section of the original image may comprise one frame of the multi-frame image.

Each further section may comprise a distinct frame of the multi-frame image, and the method may further comprise interlacing the plurality of generated blocks according to their assigned locations to form the first layer. Generation of the multi-frame image as an original image may comprise generating a plurality of frames, each frame comprising an input image at a different location within the frame; and defining an arrangement of the plurality of frames, the arrangement comprising a grid.

In methods of the invention using interlacing, there are, in effect, three key processes being performed: frame generation; interlacing of portions of the frames with one another; and frame skip correction by mirroring. Frame generation takes place before interlacing (since interlacing is based on the existence of multiple frames in a multi-frame image). The frame skip correction by mirroring takes place after frame generation, but can occur before or after interlacing. The content of the image (input image) from which frames of the multi-frame image are generated and the content of the image (original image) from which first and further sections are selected to generate first and further blocks will differ depending on the timing of the correction by mirroring. In embodiments where correction by mirroring occurs after interlacing is complete, the input image may be an image not yet manipulated in any way and the original image is an interlaced version of that input image. In embodiments where correction by mirroring occurs during interlacing, the input image is the same (an image not yet manipulated in any way), the original image is the multi-frame image generated from the input image, and the first section is a frame (i.e., the first section may consist of one frame) of the multi-frame image, such that the first block is a mirrored frame (mirrored in both the x and y directions). Further blocks are further mirrored frames, and the interlacing is then performed on the blocks, which are mirrored frames.

It will be appreciated that defining an arrangement of the plurality of frames, that arrangement being a grid, could entail producing the grid as an actual entity stored in memory, or could entail merely assigning a data flag to each frame and its content such that the interlacing algorithm understands the position of each frame with respect to the interlacing steps. In other words, the arranged frames may exist as an arranged grid, for example as would be recognised by someone viewing the arrangement, or the frames may have associated metadata allowing the interlacing algorithm to derive the position of the frame within a nominal grid for the purposes of performing the steps of interlacing.

The first and/or further sections may be selected to be a square.

In a second aspect, there is provided a method for producing a printed image for a security feature, the method comprising: printing a printed image designed in accordance with the first aspect. Printing in this context comprises producing a physical representation of the printed image, the data for which may be stored on a computational device.

In a third aspect, there is provided a printed image for a security feature, the security feature comprising an array of optical elements overlaying the printed image, the printed image comprising: a first layer, the first layer comprising a first block, the first block comprising pixels of a first section of an original image mirrored in both x and y directions. Physically printed images designed in accordance with the methods of the first aspect are advantageous because they allow for security features which are more distinctive than security features based on known printed images, for the reasons described in relation to the first aspect.

The first layer may further comprise: one or more further blocks, each further block comprising pixels of a respective further section of the original image mirrored in both x and y directions.

The printed image may further comprise: a second layer, the second layer comprising a second block, the second block comprising pixels of a first section of a second original image mirrored in both x and y directions.

The first and/or second layer may be rotated relative to the x and y directions by a rotation angle, optionally wherein the rotation angle is between 0.1° and 5°, for example, between 0.1° and 2°, between 0.1° and 1°, or, preferably, between 0.1° and 0.6°.

In a fourth aspect, there is provided a security feature comprising: the printed image of the third aspect; and an array of identical optical elements overlaying the printed image.

In a fifth aspect, there is provided a security document comprising the security feature of the fourth aspect. A security document in this context may be any document for which a mark of authenticity may be useful or required in order that the document serve its purpose.

The security document may be one of a banknote, a passport, a driver's license, and an identification card, or the like.

In a sixth aspect, there is provided a non-transitory computer readable medium, storing computer readable instructions, which when executed, cause a machine comprising a processor to perform the method of any of the first aspect.

### BRIEF DESCRIPTION OF THE DRAWINGS

FIG. 1 depicts a plan view of a security feature according to the present invention;

FIG. 2 depicts a cross-sectional view of a security feature according to the present invention;

FIG. 3 depicts a multi-frame image for use in methods of interlacing according to the present invention;

FIG. 4 depicts a method of interlacing according to the present invention;

FIG. 5 depicts a method of sampling according to the present invention;

FIG. 6 depicts a plot of frame number against pixel number to demonstrate the problem of frame-skip in un-corrected security features;

FIG. 7 depicts a security feature having un-corrected printed image at three simulated optical viewing angles;

FIG. 8 depicts a security feature having a corrected printed image at three simulated optical viewing angles according to the present invention;

FIG. 9 depicts a method of frame-skip correction by mirroring according to the present invention;

FIG. 10 depicts a plot of frame number against pixel number to demonstrate eliminated frame-skip effect in a corrected security feature;

FIG. 11A depicts a security feature having an un-corrected and rotated printed image at three simulated optical viewing angles, demonstrating horizontal tilt only;

FIG. 11B depicts a security feature having a corrected and rotated printed image at three simulated optical viewing angles, demonstrating horizontal tilt only, according to the present invention;

FIG. 12 depicts a portion of a security feature having an array of optical elements overlaying a rotated printed image according to the present invention;

FIG. 13 depicts a security feature having a corrected and rotated printed image at four simulated optical viewing angles, demonstrating horizontal and vertical tilt, according to the present invention;

FIG. 14A depicts a security feature having a corrected and rotated printed image at four simulated optical viewing angles, demonstrating horizontal and vertical tilt, according to the present invention;

FIG. 14B depicts the security feature of FIG. 14A at six, alternative, simulated optical viewing angles;

FIGS. 15A to 15D depict a method of generating a first layer from an original image according to the present invention; and

FIGS. 16A to 16C depict a method of generating a first layer from an original image according to the present invention.

### DETAILED DESCRIPTION

Certain exemplary embodiments will now be described to provide an overall understanding of the principles of the structure, function, manufacture, and use of the devices, systems, and methods disclosed herein. One or more examples of these embodiments are illustrated in the accompanying drawings. A person skilled in the art will understand that the devices, systems, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

### The Security Feature

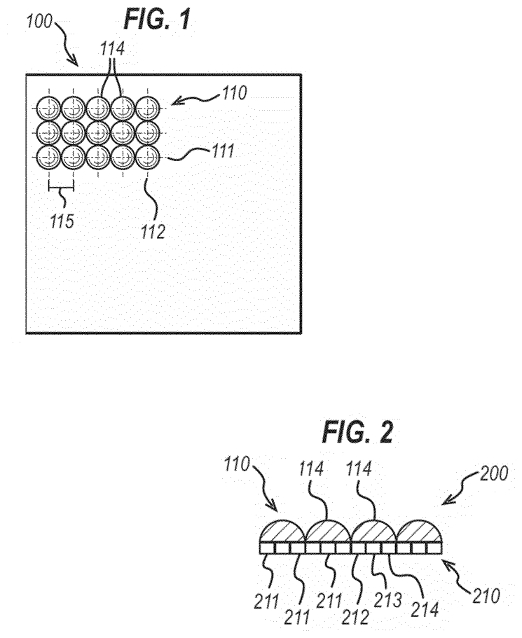

FIG. 1 shows an exemplary security feature 100 comprising an array 110 of optical elements 114 having a width 115. Each array comprises a plurality of optical elements 114 arranged in parallel rows 111 and columns 112. In some preferred embodiments, the optical elements may be lenses, and the array of optical elements may be an array of lenses. In a further preferred embodiment the lenses may be round lenses. In another preferred embodiment the lenses may be square lenses. In other embodiments the lenses may of other shapes that tessellate, for example hexagonal lenses. In another embodiment the lenses may be flat lenses. In some embodiments the flat lenses may comprise Fresnel, holographic, or diffractive lenses. Many shapes of lenses are envisaged as being used, and the above described embodiments should not be interpreted as limiting.

FIG. 2 shows an exemplary security feature 200 comprising an array 110 of optical elements 114 overlaying a printed image 210, wherein the printed image comprises a two dimensional matrix of rows and columns of pixels 211. The printed image may comprise a series of frames, wherein the frames may be different frames of an animation or different perspective views of an image, and wherein the frames may be interlaced in both dimensions of the two dimensional matrix. This interlacing means that a user will see a pixel from a different frame 212, 213, 214, 215 depending on the angle from which they view the security feature 200. This way, as the user tilts the security feature (or otherwise changes their position relative to the security feature), they will see different frames, either giving the impression of an animated image (if the frames are frames of an animation) or giving a false three dimensional effect (if the different frames are different perspective views of an image).

Typically, the security feature may be fabricated by printing the pixels onto a substrate to form the printed image and then overlying the substrate with an array of optical elements. In some embodiments the security feature may comprise printing the printed image on a first side of a polymer film and applying an array of optical elements to the other side of the polymer film. In some embodiments, an array of optical elements may be applied as sheets or directly cast on top of a printed image. In some embodiments the security feature may comprise an array of optical elements that focus onto an internal surface of the security feature.

In principle, it would be ideal to produce optical elements and pixels to the exact dimensions that are designed, and that the width of an optical element would be an integer multiple of the width of a pixel such that an integer number of pixels fit exactly under each optical element. For example, a typical optical element may have a nominal design size of 70 microns, and a pixel may have a nominal design size of 2.5 microns which would result in 28 rows (or columns) of pixels under each optical element. This would lead to the viewing experience described above, wherein a user will see a different frame depending on the angle from which they view the security feature 200, and they would see the same pixels from only one frame across the entire image.

The content of the printed image underlying the array of optical elements directs the appearance of the security feature when viewed through the optical elements. Integral images, being images created via an integral imaging process, allow for certain distinctive effects to appear in the security feature.

### Producing an Integral Image

Integral imaging is a process by which three-dimensionality can be implied from a two-dimensional object. Crude integral imaging uses photography with a number of lenses and then arranging all of the photographed images through a single array to produce a three-dimensional effect. Photographic interlacing is labour intensive, and is restricted in the effects it can produce.

Computational integral imaging can be used to recreate simplified versions of three-dimensional objects, but it also provides a great deal of design freedom by which the image can be simplified further. Printed or displayed objects are perceived as three-dimensional in two ways: firstly, if they present slightly different views to each eye simultaneously, secondly if they appear to move in a way that is counter to the display medium, when the display medium is moved relative to the viewer.

The process of generating three-dimensional views can be simplified as such: two-dimensional objects will appear to be located on planes above or below the plane of a print if they move either faster than their backgrounds or in the opposite direction. These objects will also satisfy the binocular requirement of three-dimensionality, since they will appear slightly different to each eye in a manner consistent with their movement. Complex three-dimensional images composed of objects located on different planes can be built up in this manner.

Animating flat objects to move to give the appearance of depth does not require multiple three-dimensional views, but can be done from a single image. There are two ways to convert single images to such animations:
(a) Creating multiple image frames in which each object is moved slightly relative to its previous frame and then interlacing them together. For example, a three dimensional animation using a 70 micron lens and 10 micron frame sizes, would require 49 of such frames, each with the object moved slightly.
(b) Replicating the integral imaging process by “viewing” the image through a series of “lenses”. In other words, sampling and cutting sections of the image and placing them alongside one another on a new image. The sampling is performed by iterating the x/y origin of the sample window by degrees that are less than the size of the samples.

Two integral imaging processes are detailed herein: interlacing and sampling.

### Interlacing

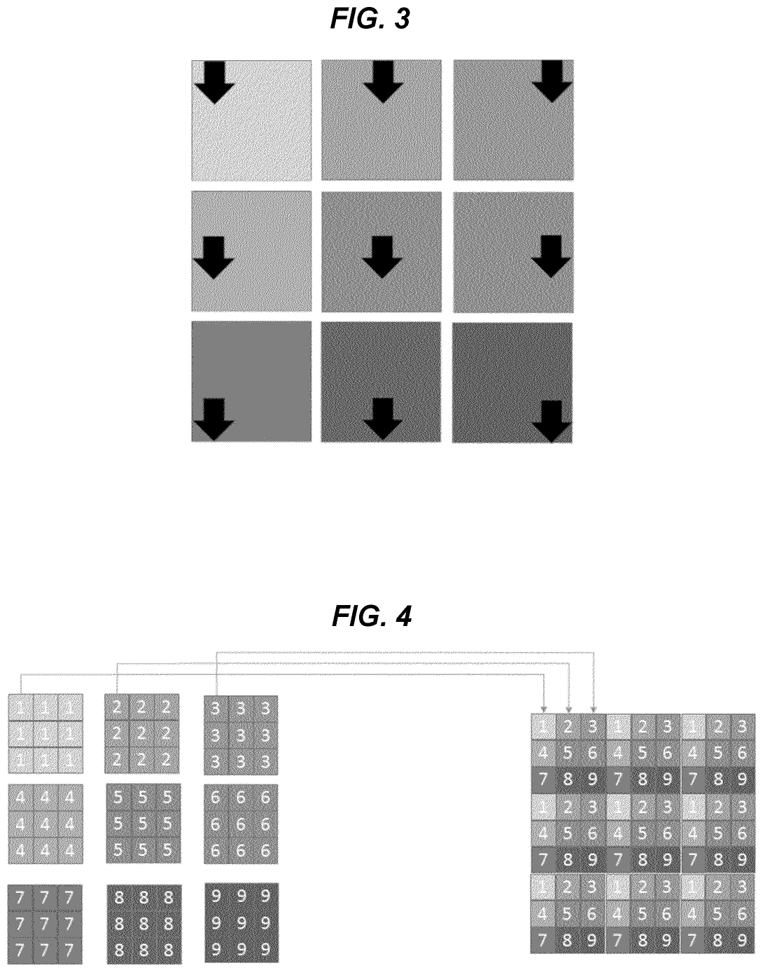

An interlacing process begins with generating a multi-frame image. The frames are selected to give rise to a particular effect in the security feature, as detailed with respect to FIG. 2. The first stage of this is to create some frames; FIG. 3 illustrates this process. The frames are shaded for the purposes of this explanation and only nine are shown for the purposes of simplification, but this is exemplary only, and any number of frames may be used and their shading may be kept uniform. The central frame contains an arrow and the frames around the centre contain arrows moved to positions that are consistent with where the object would be expected to move on a tilted micro-optic—these are the animation frames, and are analogous to frames of an animation in a movie, but here the frames of the animation are associated with different viewing directions arranged in a grid.

Once the frames are generated, each is split into a plurality of component parts, which are then reassembled as a larger output image. FIG. 4 shows this. In FIG. 4, it can be seen that the shaded and numbered frames retain their relative positions with respect to one another in the finished design, but are taken apart pixel by pixel and mixed together to form the larger image (again, tiny images of only 3×3 pixels are represented, the real images could be any size, and may be much larger).

Each repeating cycle of images can be designed to fit under a single lens in the output design so that when the user views the optic from an angle the identical frame will be magnified by all the lenses (e.g. from the normal, the viewer would see all pixels of the image frame denoted ‘5’).

A further step of pitch correction can be applied to correct for the fact that the lens and the print pitches are very unlikely to match, so the displayed frame may move as a viewer moves across the image. However, this step is not necessary and may in fact be deliberately omitted since the mismatch between the lens array and the print add to the sense of depth.

Formally, this relationship can be written as:

$${P}_{( xw ) + i , ( yh ) + j} = {P}_{x , y , i , j}^{o} \qquad ( 1 )$$

### Where:

P_{x,y,i,j}^{o} is a pixel on one of the image frames;
x and y are the frame column and row positions;
i and j are the pixel column and row positions;
P is a pixel on the new image at the position calculated; and
w is the width of each frame and h is the height of each frame (all the frames are generally the same size).

The output image size is equal to the total width and height of all the individual frames.

### Sampling

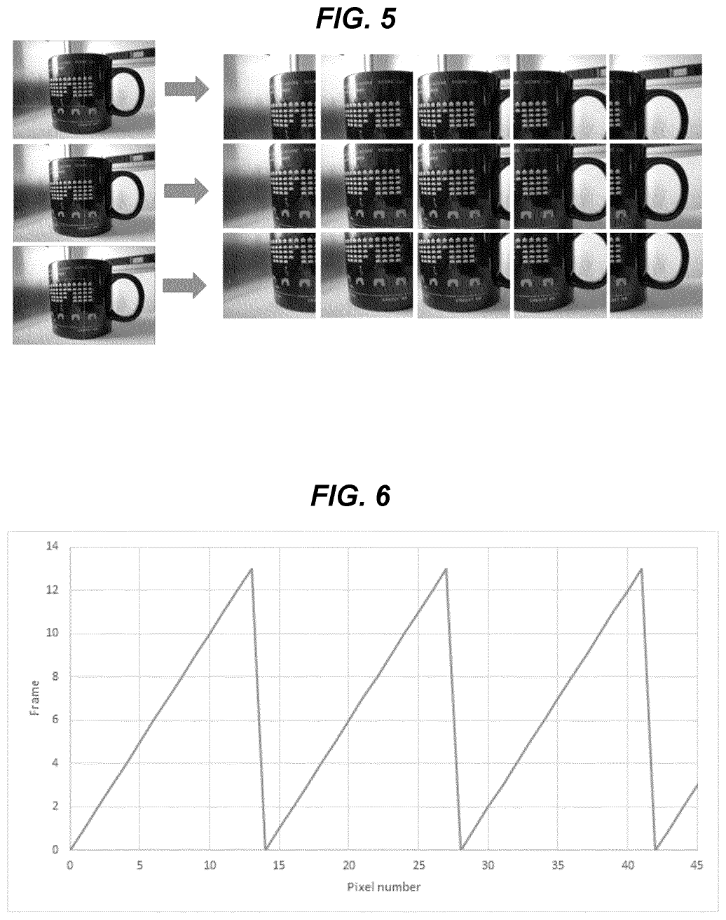

A sampling technique may also be used to produce an integral image. A sampling technique has the advantage of being faster and using fewer system resources; in this case, instead of generating multiple frames by moving the objects within an image around, a single image is used and sampled at positions which are incremented at intervals smaller than the frame size. FIG. 5 shows an example of this. The first column of pictures on the right-hand side of the arrow is generated by cutting out the boxes shown on the images on the far left. As can be seen, the box is large (in this case 100×100 pixels) and is moved downwards at a rate half of its size (i.e. each box is offset by 50 pixels), so in this case it covers the height of the image in three cuts. The same process happens in the x-axis, where five cuts are needed to cover the width of the image. The final image is shown with spaces between each section for ease of illustration (although in reality, there would be no spaces between adjacent sections). As with interlacing, each section is equal to the size of a lens on the lens array. The number of cuts and number of pixels in the image is simplified here; there may be any number of cuts, often thousands.

Designs created by this method and those created via interlacing a series of frames are intended to perform in the same way. The sampling method does not create any extra unwanted images and can be optimised to copy only specific colours (for example excluding white, which need not be copied), so the resulting processing can be faster with sampling than with interlacing.

Formally, the relationship is:

$${P}_{{mC}_{w} + i , {nC}_{h} + j} = {P}_{{mI}_{x} + i , {nI}_{y} + j}^{o} \qquad ( 2 )$$

### Where:

P is the pixel on the new image; for a real design, the dimensions of the output control the design process—since the design dictates the required size;
P^{o} is the pixel on the old image;
C_{w} and Cₕ are the cut out width and height which are equal to the diameter of the lenses for a normal two dimensional lens system or one of them is equal to the height of the output image for a lenticular array;
Iₓ and I_{y} are the increments between cut-out sections in the x and y axes. Usually, this is presented as the magnification in raw or scaled to the size of the output;
i and j are the row and column positions on the cut-out, which have values of 0 to C_{w} and 0 to Cₕ respectively;
m is the lens column in the lens array and has values of 0 to mₘₐₓ=w/F where w is the width of the P and F is the pitch of the lenses in the array; and
n is the lens row in the lens array and has values of 0 to nₘₐₓ=h/F where h is the height of P and F is the pitch of the lenses in the array.

The input image may need to be resized to accommodate a particular increment size. The size is: width=mₘₐₓIₓ+F×height=nₘₐₓI_{y}+F.

As can be seen from equation (2), this method is effectively another method of interlacing, but using a single image and interlacing with itself.

Sampling may introduce an error between the lenses and the printed image, i.e., a growing mismatch between the beginning of a pixel in the printed image and the beginning of a lens in the array of lenses; this can occur in both the x and y directions. If the error exceeds one pixel in width, the sampling algorithm may skip a column or row of the original image. In practice, this will have little effect on the finished feature, and need not be addressed at all, but it can be corrected by the simple process of copying the following row or column of pixels backwards.

The point of correction can be found when the following conditions are satisfied:

$$mF - ( int ) mF < ( m - 1 ) F - ( int ) [ ( m - 1 ) F ] \qquad ( 3 )$$

### Where:

m is the lens number;
F is the real size of the lens in microns; and
(int) is a computing term which essentially rounds the terms after it down. In other words, when the error is lower than the error for the previous lens; with the error being the difference between the raw value and the value after being rounded down.

Finally, the direction of movement can be controlled by inverting the cut-outs before placing them; inversion can be one or both axes and is analogous to the negative/positive magnification parameters found in moiré magnifiers. The resulting effects are the reversal of movement with respect to tilting in one or both axes—rotating movement can be reversed from clockwise to anti-clockwise.

### Correcting the Integral Image

Computational integral images created in any way, for example via sampling and interlacing as detailed above, suffer from a further problem: if the optic is tilted too far, then the animation will jump from the last frame back to the first frame. FIG. 6 shows how the relationship between frames and pixels works in one dimension—of course, the relationship happening in both the x and y directions in reality.

The phenomenon of frame skip arises where the security feature is tilted at an angle such that the viewer sees information printed under one of the adjacent lenses. The tilt angle at which frame skip, or frame jump, happens is determined by the lens design; for micro-optics this is usually +/−30°, but it can vary. Once the limit angle is exceeded, the viewer is no longer looking at information printed directly under each lens, but rather every lens is now focusing on information printed under adjacent lenses.

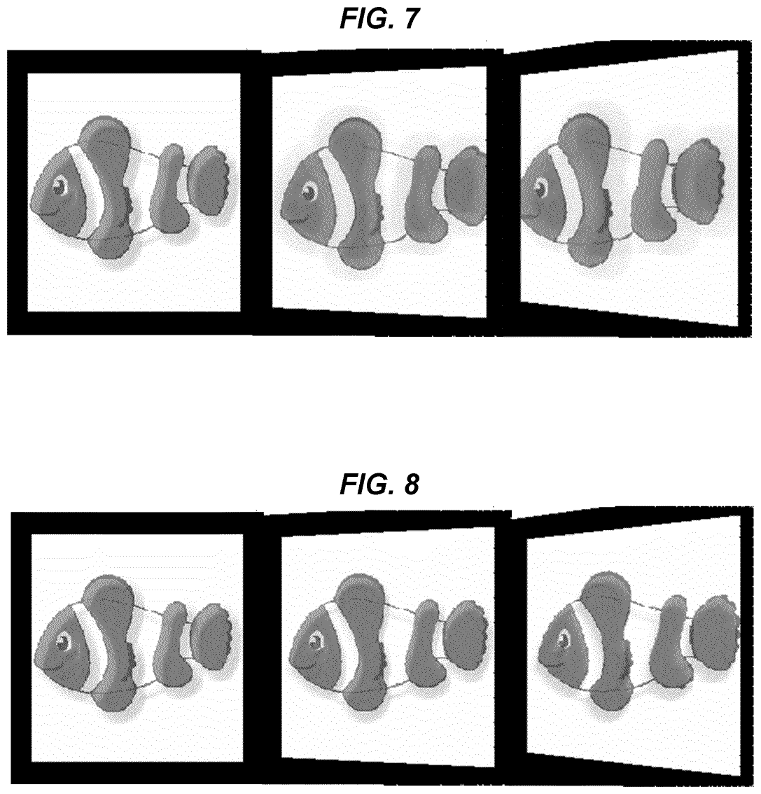

Frame skip is demonstrated in FIGS. 7 and 8, using a security feature depicting a clownfish. FIG. 7 simulates a printed image not corrected to eliminate frame skip, FIG. 8 simulates a corrected printed image.

Where simulated security features are referred to herein and where these are shown in the Figures, these are depicted as stills from an animation. The animation is a computational simulation of the appearance of a physical security feature as the ‘viewing angle’ at which it is viewed is varied. In all cases depicted herein, the simulated viewer is viewing orthogonal to the page, so varying the viewing angle is achieved by simulating a tilt of the security feature, although it will be appreciated that the effect would be identical for a stationary security feature and viewer moving in an arc around the security feature.

Both Figures present the progression of an animation as the viewer tilts the security feature from the normal (i.e., 0° to the viewer) in the horizontal plane only, with the left hand side of the security feature rotating into the page, the right rotating out of the page. There are minor differences between the leftmost and central stills for the uncorrected and corrected security features, which arise from the correction. However, in the final frame, at the most extreme angle of rotation to the viewer, the uncorrected security feature (FIG. 7) skips in the opposite direction to the natural direction that the viewer would expect. In both the leftmost and central stills of FIG. 7 and FIG. 8, the clownfish moves across the frame as would be expected if the security feature was three-dimensional (i.e. if the clownfish was, in fact, underneath the page and being viewed through a window). The clownfish slides towards the right of the still. The extent to which this occurs is reduced in FIG. 8, but is still evident.

However, in the rightmost still of FIG. 7, the clownfish ‘skips’ back towards the left of the still, breaking the illusion of depth. This effect arises because the lenses are now focusing on the rightmost edge of frames adjacent to those that they are designed to focus onto.

The corrected security feature (FIG. 8) does not suffer this frame skip, and instead continues to transition smoothly. Thus, in the rightmost frame of FIG. 8 (at the maximum simulated tilt), the clownfish is furthest to the right. The lenses of the corrected security feature are still focusing onto the adjacent frames, as is the case for the security feature of FIG. 7, but the printed content of the frames has been configured such that this optical effect does not produce frame skip. The design method by which this is achieved will now be described.

The jump from last frame to first frame will have a significance that is dependent upon design. However, rather than relying upon design to correct this, it is possible to create a general condition by which it can be controlled.

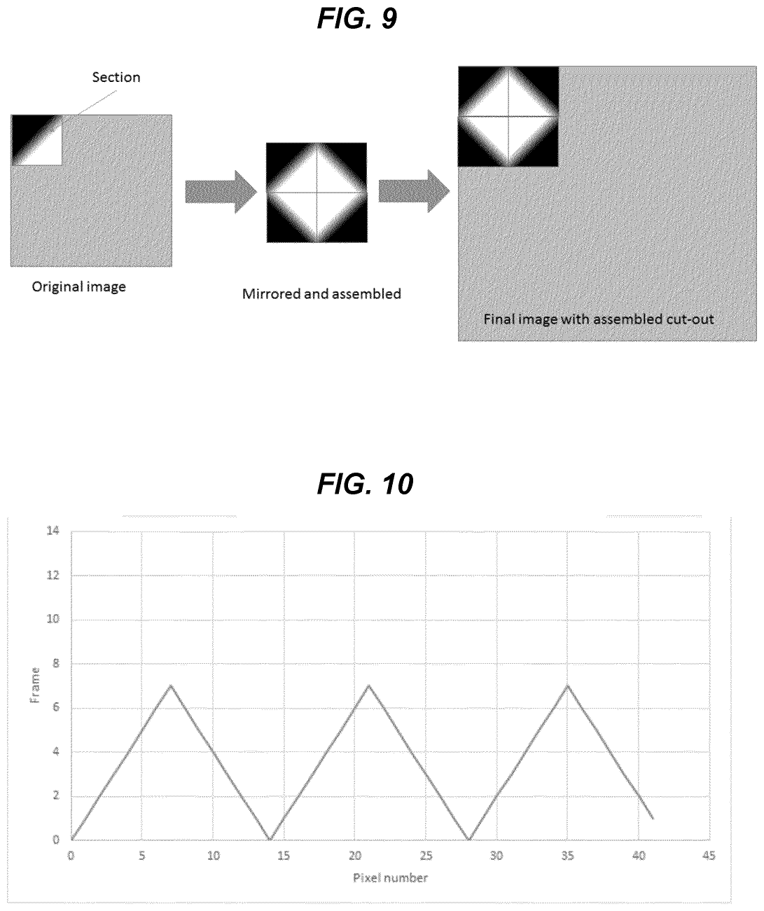

Instead of animating with the full 14 frames (the progression for which is shown in FIG. 6), the number of frames can be halved and then mirrored. FIG. 9 shows a schematic of a single cut-out being cut, mirrored and reassembled. The cut-out has dimensions of half that of the uncorrected cut out and is mirrored in both the horizontal and vertical axes before reassembling.

This method results in simpler animations that take a quarter of the number of frames from the original. The frame progression graph becomes FIG. 10; the effect is to halve the number of frames (in each dimension) and create a reverse cycle where the animation returns to the original point. As before, this can occur in two-dimensions.

Equation (2) becomes a series of four equations, overleaf, where:
P and P^{o} are pixels on the new and original images respectively;
F is the lens diameter;
m is the lens column index that runs from 0 to mₘₐₓ=w/F, where w is the width of the output image;
n is the lens row index that runs from 0 to nₘₐₓ=h/F, where h is the height out the output image;
i and j are the indices of the cut out; and
Iₓ and I_{y} are the increments between cut-out positions.

The input image may need to be resized to mₘₐₓIₓ+(F/2), nₘₐₓI_{y}+ (F/2).

$${P}_{{mC}_{w} + i , {nC}_{h} + j} = {P}_{{mI}_{x} + i , {nI}_{y} + j}^{o} when i = 0 to ( F / 2 ) - 1 , j = 0 to ( F / 2 ) - 1 \qquad ( 4 )$$

$${P}_{{mC}_{w} + i , {nC}_{h} + j} = {P}_{{mI}_{x} + ( F / 2 ) - i , {nI}_{y} + j}^{o} when i = F / 2 to F - 1 , \\ j = 0 to ( F / 2 ) - 1 \qquad ( 5 )$$

$${P}_{{mC}_{w} + i , {nC}_{h} + j} = {P}_{{mI}_{x} + i , {nI}_{y} + ( F / 2 ) - j}^{o} when i = 0 to ( F / 2 ) - 1 , \\ j = F / 2 to F - 1 \qquad ( 6 )$$

$${P}_{{mC}_{w} + i , {nC}_{h} + j} = {P}_{{mI}_{x} + ( F / 2 ) - i , {nI}_{y} + ( F / 2 ) - j}^{o} when i = F / 2 to F - 1 , \\ j = F / 2 to F - 1 \qquad ( 7 )$$

As before, the cut-outs can be inverted to alter the movement of the feature in a manner analogous to the positive/negative magnification of moirés. For the corrected integral image, this can be done by either reflecting the cut-out across one or both axes, or by simply assembling the cut-out in a different order; both methods result in the same output design.

### Applying Rotation

Integral imaging, via interlacing or sampling, changes the order in which the frames in an animation play from a linear one to a cyclic one; in a two-dimensional animation this changes in both axes. Rotating the design by a small amount creates a double relationship between the frames and position, which for a cyclic device generates a distinctive effect.

Design rotation is carried out by a standard image rotation matrix transform. The transformation matrix is shown in equation (8):

$$R ( θ ) = [ \begin{matrix}cos θ & - sin θ \\ sin θ & cos θ\end{matrix} ] \qquad ( 8 )$$

Which is a 2×2 matrix where the coefficients are:

$$A = [ \begin{matrix}a & b \\ c & d\end{matrix} ] \qquad ( 9 )$$

Image transformation is usually performed using inverse matrices; the reason for this is that the transformed image is the target image, which if some coordinates have no pixels, will contain tears when an image is transformed. The solution is to start with the finished image and find pixels on the original image which, when transformed, fit the desired pixels on the target image.

A 2×2 matrix can be inverted using the formula:

$${A}^{- 1} = {[ \begin{matrix}a & b \\ c & d\end{matrix} ]}^{- 1} = \frac{1}{ad - bc} [ \begin{matrix}d & - b \\ - c & a\end{matrix} ] \qquad ( 10 )$$

Which, when applied to the x, y coordinates of an image:

$$[ \begin{matrix}{x}^{′} \\ {y}^{′}\end{matrix} ] = \frac{1}{ad - bc} [ \begin{matrix}d & - b \\ - c & a\end{matrix} ] [ \begin{matrix}x \\ y\end{matrix} ] \qquad ( 11 )$$

Solving the matrix for x′ and y′ gives:

$${x}^{′} = \frac{xd - yb}{ad - bc} \qquad ( 12 )$$

$${y}^{′} = \frac{ay - xc}{ad - bc} \qquad ( 13 )$$

Since we wish to be able to control the central point of the transform and the destination, we need to add adjustment parameters, xₛ, yₛ (x and y source), and x_{d}, y_{d} (x and y destination).

$${x}^{′} = [ \frac{( x - {x}_{d} ) d - ( y - {y}_{d} ) b}{ad - bc} ] + {x}_{s} \qquad ( 14 )$$

$${y}^{′} = [ \frac{a ( y - {y}_{d} ) - ( x - {x}_{d} ) c}{ad - bc} ] + {y}_{s} \qquad ( 17 )$$

Referring back to equations (8) and (9):
a=cos θ, b=−sin θ, c=sin θ, and d=cos θ

A further advantage of using the reverse transform is that the standard form of transform functions is usually as forward transform, so there is no further need to reverse the transform coefficients to add new types of transforms. Additionally, the rotation transform changes from anti-clockwise to clockwise.

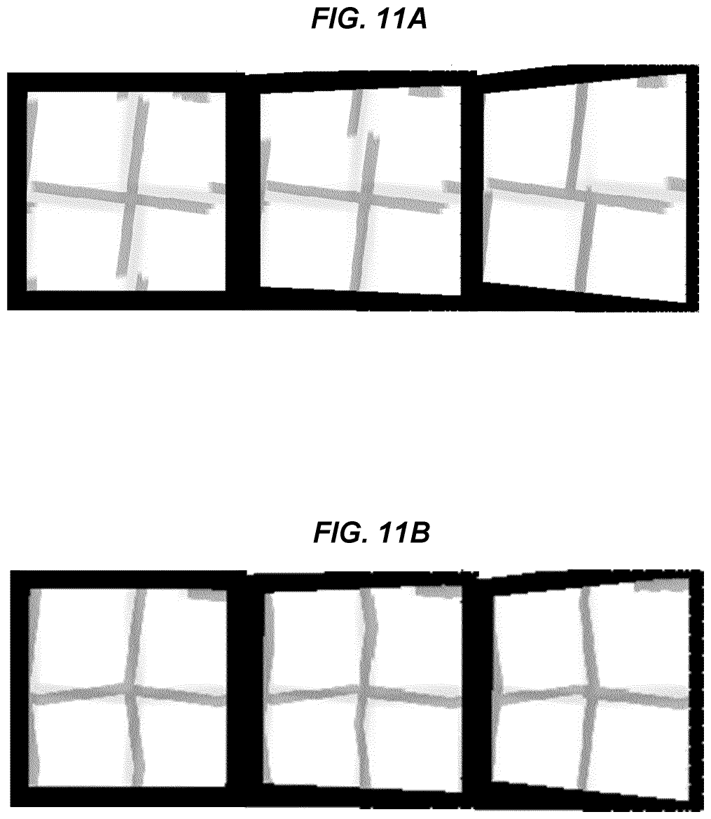

If a small rotation, for example 0.2°, is implemented between the printed image and the lens array, then the x and y axes of the design will no longer match up with those of the lenses. The x axis of the design will interact with the y axis of the lens to a small degree—this adds a second animation cycle into the animation. In a physical security feature, the rotation can be affected on either the printed image, the lens array, or both. The effect of this can be seen for uncorrected and corrected security features in FIGS. 11A and 11B. The stills shown in these Figures are stills from simulated animations, produced in the same manner as described in relation to FIGS. 7 and 8.

The uncorrected grid (FIG. 11A) runs in a diagonal direction and resets itself once the last frame to first frame jump happens. A vertical ‘screen wipe’ effect appears, as the next set of frames gradually becomes focused, not all at the same time. The corrected version (FIG. 11B) cycles back and forth in a triangular cycle which is flat enough to appear sinuous to the viewer. FIGS. 11A and 11B depict a pattern having horizontal and vertical lines; the printed image below the optical elements here is a simple grid. As can be seen, tilting the optic in one axis results in the lines of only one axis moving. In other words, the lines of the grid which are closer to the horizontal do not animate when the security feature is tilted in the horizontal plane (i.e. where the horizontal centre of the top and bottom edges of the security feature remain the same distance from the viewer). Tilting the security feature vertically would give the appearance of the horizontal grid line oscillating, and the vertical grid line remaining still (albeit no longer straight).

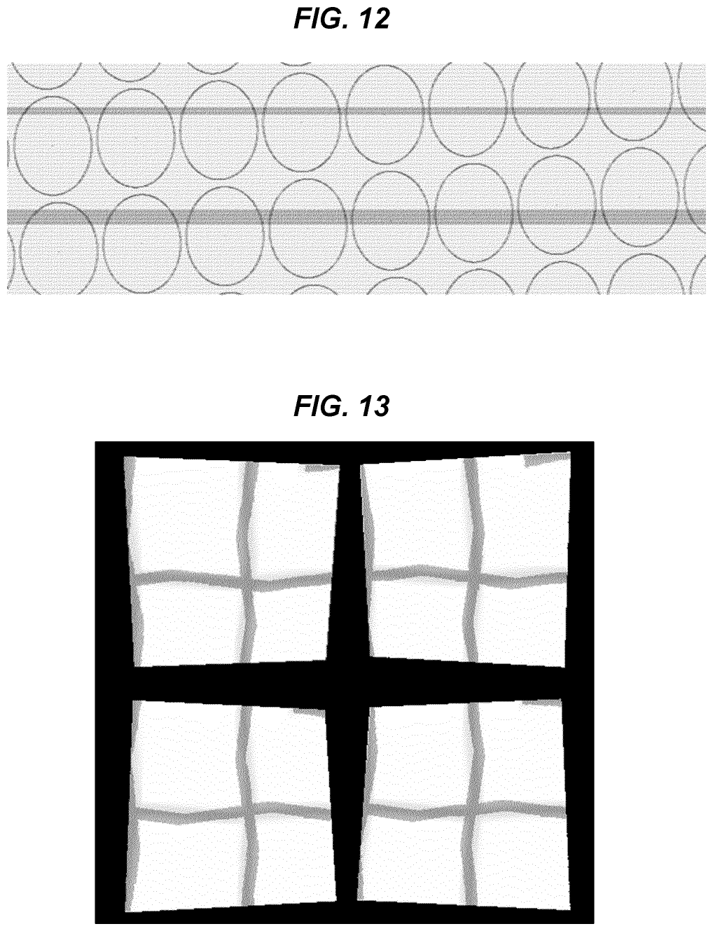

The reason for this second axis relationship can be seen in FIG. 12; horizontal lines run across the diagram and are covered by lenses (in this case, the image is rotated by 4° relative to the lens array to exaggerate the effect for the purpose of illustration). As one moves from the left to the right side of the image, the line drops with respect to the line of lenses. If an optic designed in this way is tilted vertically, then the vertical position of the lens focus will move up and down; as it does, the point at which the printed line intersects with this will move from side-to-side (the opposite of what can be seen on FIG. 4).

In reality, a viewer will apply tilt to security features in more than one axis, in a rolling motion. This is in part due to this being a well-known way to view features such as these, and also because it is impossible for a viewer manually to apply motion precise enough to tilt the feature in only one axis.

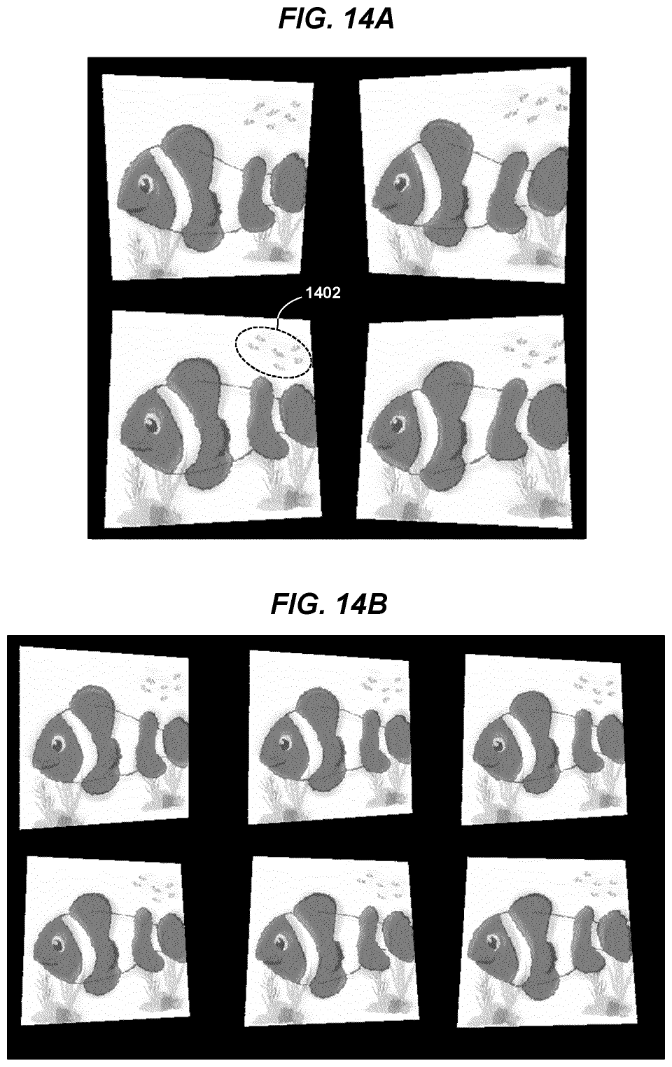

FIGS. 13 and 14A show the effect created when horizontal tilt is applied to security features having printed images which have been corrected for frame skip and have also had a rotation applied, such that the printed image and array of optical elements are offset by a rotation angle. Of course, the rotation can instead be applied to the optical array to achieve the same effect; what is important is a rotational offset between the printed image and the overlaying array of optical elements.

FIG. 13 shows the same grid pattern depicted in FIGS. 11A and 11B, but now with both horizontal and vertical lines oscillating in a sinuous manner.

FIG. 14A shows the clownfish of FIGS. 7 and 8, now with a rotation applied to the printed image. The clownfish can now be seen to have sinuous motion, akin to being viewed underwater where the viewer's perspective would be distorted by a moving water/air boundary. In both FIGS. 13 and 14A, four stills from a simulated animation of the security feature are depicted. In both cases, the top left still shows the top left corner of the feature ‘out of the page’, the top right still shows the top right corner of the feature ‘out of the page’, and so on.

FIG. 14A also highlights how different layers of a printed image can be overlaid, or composited, to produce more distinctive security features, including more complex motion. The school of smaller clownfish (1402) in the background of the image have been produced as a second layer of the printed image. The single clownfish and school of clownfish, having begun as separate original images, have been interlaced or sampled, corrected, and then rotated. The rotation is therefore applied to each independently, and a different rotation angle has been applied in this case. The result is that each appears to have a different degree of oscillation, or “waviness”; the school of fish have had a greater angle of rotation applied, and thus appear to oscillate more. This may be appropriate in this case, for example, because the school of fish are in the background and therefore their greater oscillation provides enhanced perception of depth in the image. In general, however, the ability to produce security features in which objects appear to oscillate when the feature is tilted provides more distinctive security features that are more difficult to counterfeit via reverse engineering the printed image. This difficulty in counterfeiting is compounded by more complex security features in which layers, each with a different magnitude of oscillation, are composited to form the printed image.

FIG. 14B shows the same simulated security feature as shown in FIG. 14A. In FIG. 14B, however, the change in simulated viewing angle between each still has been minimised (i.e., each still represents a smaller amount of tilt away from the position of its adjacent still). FIG. 14B demonstrates the progression of a corrected, and rotated, security feature as the security feature is tilted. The sinuous effect produced by appropriate manipulation of the printed image according to methods of the invention is visible in the progressive change in shape and size of features of the clownfish, and school of clownfish, in each still. For example, the dorsal (top) fin of the clownfish appears to compress and lean to the right, and the locations relative to one another of each fish in the school of clownfish vary. As described in detail herein, a counterfeiter only has access to the animated security feature, and must ‘reverse-engineer’ the underlying printed image in order to counterfeit the security feature. Complex animated effects such as sinuous, water-like, oscillation, allow for the production of security features which are more difficult to reverse-engineer. Furthermore, the distinctive nature of the effect is easily recognisable and distinguishable from other animated effects. This means that the speed and ease with which a genuine security feature can be verified is increased.

### Exemplary Methods

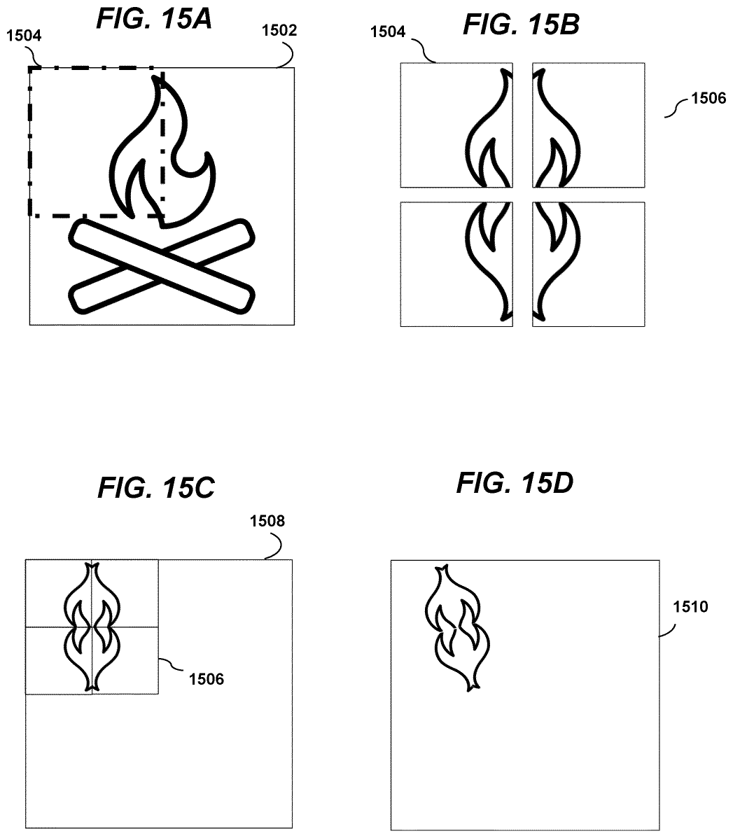

An original image 1502 is shown in FIG. 15A. A first section 1504 is selected, here the top left, shown as a dashed line in the figure. FIG. 15B shows mirroring of the first section 1504 in both the x and y directions. The x and y directions may be defined as the intended horizontal and vertical axes of the original image.

The combination of the content of the first section 1504 and the mirrored portions form the first block 1506. The first block 1506 is shown with boxes surrounding the content of the first section 1504 and the mirrored portions. It will be appreciated that this is to demonstrate the construction of the first block 1506, and that the box-lines may not be reproduced in the first block 1506 during operation of the method.

The first block 1506 may be resized and may be positioned in a first layer 1508 of the printed image, in a location corresponding to the location of the first section in the original image, as shown in FIG. 15C. One or more further blocks may be produced from one or more sections of the original image according to this same method. This method therefore represents a form of sampling. The sections of the original image may overlap with one another, as shown in FIG. 5.

A rotation angle may then be applied to the first layer 1508, as shown in FIG. 15D. In FIG. 15D, the first layer 1508 comprises only the content of the first block 1506, thus this is all that has been rotated. The rotated first layer 1508 is comprised within the printed image 1510. An array of optical elements arranged to overlay the printed image 1510 will then then offset from the printed image by the rotation angle. In other words, the array of optical elements will be offset from the x and y directions of the printed image, wherein the x and y directions of the printed image are those directions before rotation of the first layer 1508, i.e. the directions about which the first section 1504 was mirrored.

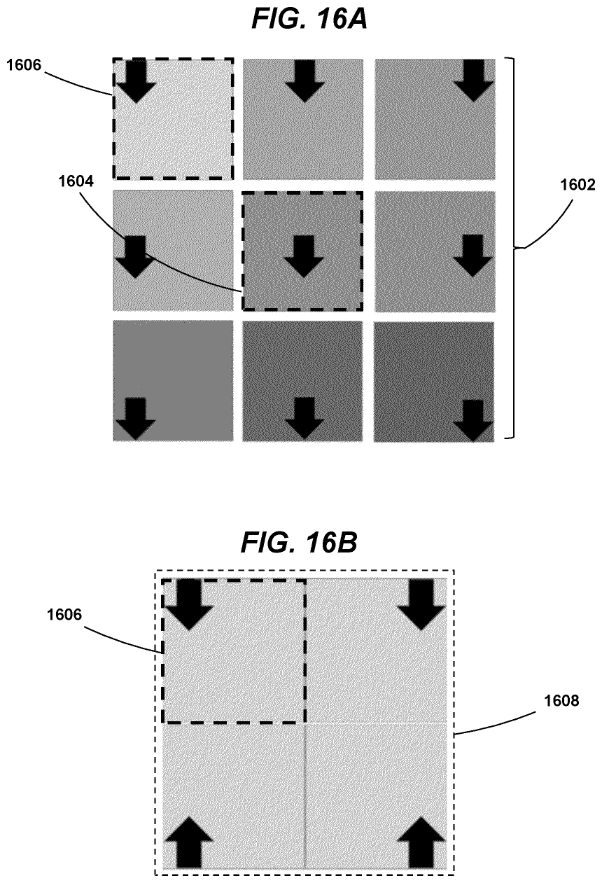

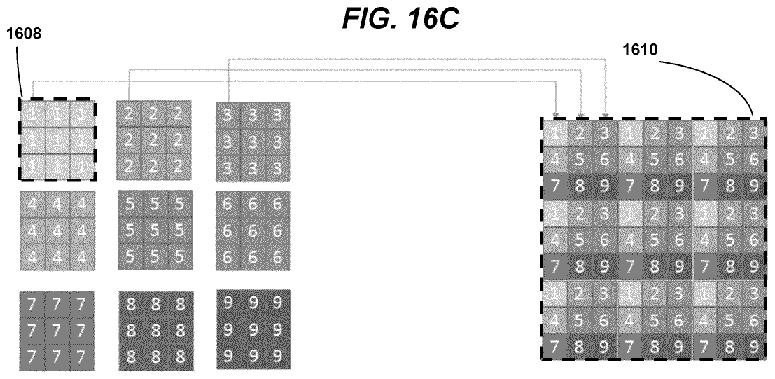

In an alternative embodiment, using a method of frame-skip correction according to the invention, the original image is a multi-frame image comprising a plurality of frames. To illustrate this embodiment, the content of FIGS. 3 and 4 is re-used as FIGS. 16A to C.

FIG. 16A shows a multi-frame image 1602, here produced from an arrow positioned in the centre of an image. This image is the central frame 1604, and additional frames are generated to surround the central frame—these surrounding frames contain arrows moved to positions that are consistent with where the object would be expected to move on a tilted micro-optic—these are the animation frames, and are analogous to frames of an animation in a movie, but here the frames of the animation are associated with different viewing directions arranged in a grid, as described in reference to FIG. 3. The frames are shaded for the purposes of this explanation and only nine are shown for the purposes of simplification, but this is exemplary only, and any number of frames may be used and their shading may be kept uniform. In this embodiment, a first section 1606 is selected to consist of one frame of the multi-frame image 1602. The top left frame is selected as the first section in this example, but it will be appreciated that any frame could be selected.

The same process that was applied to first section 1504 in relation to FIG. 15A is now applied to first section 1606 as shown in FIG. 16B. The first section 1606 is mirrored in both the x and y directions to form a first block 1608. As with frame-skip methods described throughout, mirroring in the x and y directions is performed in one of two orders: either in the x direction first or in the y direction first, to form a first block 1608. The mirroring process may then be carried out for further sections of the original (multi-frame) image 1602, each further section also consisting of a frame.

FIG. 16C shows a plurality of blocks generated according to the process described above and shown in FIG. 16B. Each block is now represented by a grid of numerals to demonstrate the interlacing process to follow. In reality, the content of each block is determined by the frame from which it originated and the mirroring process of FIG. 16B. The first block 1608, for example, is represented by a grid of ‘1’s. The plurality of blocks are arranged in the same manner that the plurality of frames of the multi-frame image 1602 are arranged. The plurality of blocks are interlaced with one another, as shown, to form first layer 1610. The interlace used in this example takes a portion of each block and arranges the chosen portions in the same arrangement defined by the blocks. For example, the top left portion of each block (a single ‘1’ from the top left of the top left block, a single ‘2’ from the top left of the top middle block, and so on), are arranged according to the arrangement of the blocks, here forming the top left three-by-three portion of the printed image 1610 which contains one each of the numerals ‘1’ to ‘9’, with the numerals progressing left to right and top to bottom, as they do for the plurality of blocks. This process is repeated until the first layer 1610 contains the content of the plurality of blocks.

It will be appreciated that the interlacing to form the first layer 1610 can be performed in any order, i.e. the first layer 1610 may be populated with portions of the plurality of blocks in any order. As described in relation to other embodiments of the invention, the first layer 1610 may be comprised within a printed image, which is overlaid with an array of optical elements to create a security feature. Furthermore, the first layer 1610 may be rotated by a rotation angle in order to produce an offset between the printed image and the overlaid optical elements.

1. A method for designing a first layer of a printed image in a security feature, the security feature comprising an array of optical elements overlaying the printed image, the method comprising:
receiving an original image, the original image comprising rows of pixels extending in an x direction and columns of pixels extending in a y direction;
selecting a first section of the original image;
generating a first block by combining the pixels of the first section with pixels of the first section mirrored in both the x and y directions; and
assigning to the first block a location within the first layer of the printed image, the location corresponding to the location of the first section within the original image.

2. The method according to claim 1, wherein generating a first block of the printed image comprises:
i) mirroring the pixels of the first section in the x direction, about the right edge of the first section;
ii) mirroring the pixels of the result of step i in the y direction, about the lower edge of the result of step i; or
i) mirroring the pixels of the first section in the y direction, about the lower edge of the first section;
ii) mirroring the pixels of the result of step i in the x direction, about the right edge of the result of step i.

3. The method according to claim 1, further comprising:
sizing the first block such that the size of the first block relative to the printed image is equal to the size of the first section relative to the original image.

4. The method according to claim 3, wherein the first block is sized to be overlaid by exactly one optical element of the array of optical elements.

5. The method according to claim 4, wherein the array of optical elements comprises rows of optical elements extending in the x direction and columns of optical elements extending in the y direction, further comprising:
rotating, by a rotation angle, the first layer of the printed image relative to the array of optical elements, such that respective rows and columns of blocks in the first layer and the rows and columns of the optical elements are offset by the rotation angle.

6. The method according to claim 5, wherein the rotation angle is between 0.1° and 5°, for example, between 0.1° and 2°, between 0.1° and 1°, or, preferably, between 0.1° and 0.6°.

7. The method according to claim 1, further comprising:
selecting further sections of the original image; and, for each further section:
generating a block, and assigning to the block a location within the printed image, the location corresponding to the respective location of the section in the original image, using the same generating and assigning steps applied to the first section and first block.

8. The method according to claim 7, wherein each block corresponds to one optical element in the array.

9. The method according to claim 5, further comprising:
receiving a further original image; and
designing a second layer of the printed image from the further original image, using the steps applied to the original image to design the first layer of the printed image, wherein the rotation angle applied to the first layer of the printed image is different to the rotation angle applied to the second layer of the printed image.

10. The method according to claim 9, further comprising compositing the rotated first and second layers to form the printed image.

11. The method according to claim 1, wherein the original image is an interlaced image.

12. The method according to claim 11, wherein an interlaced image is generated by interlacing an input image, and wherein interlacing an input image comprises:
generating a plurality of frames of a multi-frame image, each frame comprising the input image at a different location within the frame;
defining an arrangement of the plurality of frames, the arrangement comprising a grid; and
interlacing the frames with one another according to the positions of the frames in the grid.

13. The method according to claim 12, wherein the first section is selected to include only one portion of each interlaced frame.

14. The method according to claim 1, wherein the original image is a multi-frame image comprising a plurality of frames, and wherein the first section of the original image comprises one frame of the multi-frame image.

15. The method according to claim 7,
wherein the original image is a multi-frame image comprising a plurality of frames, and wherein the first section of the original image comprises one frame of the multi-frame image;
wherein each further section comprises a distinct frame of the multi-frame image, the method further comprising:
interlacing the plurality of generated blocks.

16. The method according to claim 1, wherein the first and/or further sections is selected to be a square.

17. A method for producing a printed image for a security feature, the method comprising:
printing a printed image designed in accordance with claim 1.

18. A printed image for a security feature, the security feature comprising an array of optical elements overlaying the printed image, the printed image comprising:
a first layer, the first layer comprising a first block, the first block comprising pixels of a first section of an original image mirrored in both x and y directions.

19. The printed image according to claim 18, wherein the first layer further comprises:
one or more further blocks, each further block comprising pixels of a respective further section of the original image mirrored in both x and y directions.

20. The printed image according to claim 18, further comprising:
a second layer, the second layer comprising a second block, the second block comprising pixels of a first section of a second original image mirrored in both x and y directions.

21. The printed image according to claim 18, wherein the first and/or second layer is rotated relative to the x and y directions by a rotation angle, optionally wherein the rotation angle is between 0.1° and 5°, for example, between 0.1° and 2°, between 0.1° and 1°, or, preferably, between 0.1° and 0.6°.

22. A security feature comprising:
the printed image of claim 18; and
an array of identical optical elements overlaying the printed image.

23. A security document comprising the security feature of claim 22.

24. The security document of claim 23, wherein the security document is one of a banknote, a passport, a driver's license, and an identification card.

25. A non-transitory computer readable medium, storing computer readable instructions, which when executed, cause a machine comprising a processor to perform the method of claim 1.
